(19) United States
(12) Patent Application Publication
(10) Pub. No.: US 2013/0144687 A1
(43) Pub. Date: Jun. 6, 2013

(54) METHOD AND ON-BOARD UNIT FOR SIGNALING TOLL TRANSACTIONS IN A ROAD TOLL SYSTEM

(71) Applicant: Kapsch Trafficcom AG, Wien (AT)

(72) Inventor: Dieter Smely, Schwechat (AT)

(73) Assignee: KAPSCH TRAFFICCOM AG, Wien (AT)

(21) Appl. No.: 13/684,930

(22) Filed: Nov. 26, 2012

(30) Foreign Application Priority Data
Dec. 5, 2011 (EP) 11 450 148.9

(51) Int. Cl. G07B 15/06

(52) U.S. Cl. CPC G07B 15/063
USPC 705/13

(57) ABSTRACT

A method and an on-board unit for signaling toll transactions in a road toll system with geographically distributed radio beacons, carrying out toll transactions with passing on-board units of vehicles. In the on-board unit, it is verified in the course of a toll transaction between an on-board unit and a radio beacon whether a toll transaction dates back longer than a given time span, and if so, an acoustic signal is emitted by the on-board unit, and if not, no acoustic signal is emitted by the on-board unit.

### CROSS-REFERENCE TO RELATED APPLICATIONS

This application claims priority to European Patent Application No. 11 450 148.9, filed on Dec. 5, 2011, the entire contents of which are hereby expressly incorporated by reference.

### FIELD OF THE INVENTION

The present invention relates to a method for signaling toll transactions in a road toll system with geographically distributed radio beacons carrying out toll transactions with passing on-board units of vehicles. The invention also relates to an on-board unit for executing such a method, comprising a control unit and a transponder for carrying out toll transactions with radio beacons and an acoustic signal transmitter for signaling completed toll transactions.

### BACKGROUND

With conventional road toll systems, e.g. according to the Dedicated Short Range Communication (DSRC) standard or the Wireless Access in a Vehicle Environment (WAVE) standard, the on-board units (OBUs) installed in the vehicles emit an acoustic signal once a radio beacon is passed, which signal indicates a toll transaction completed with the radio beacon. (See, for example, International Standard ISO 14906: 2004 “Road transport and traffic telematics—Electronic fee collection”, Section “SET_MMI”,) With most implementations, the acoustic signal is emitted only at the end of a toll transaction at the express request of the radio beacon, as a result, only successful toll transactions are signaled to the user.

It has been shown in practice that with longer highway journeys, where the on-board unit passes a series of successive radio beacons, the user is annoyed by the constant repetition of the acoustic acknowledge signal. The present invention provides a solution for this problem, among others, which still enables a meaningful acoustic function control.

### SUMMARY

In some embodiments, the present invention is a method for signaling toll transactions in a road toll system with geographically distributed radio beacons carrying out toll transactions with passing on-board units of vehicles. The method includes: in the course of a toll transaction between an on-board unit and a radio beacon, verifying whether a toll transaction stored last in the on-board unit together with a timestamp dates back longer than a given time span; if so, emitting an acoustic signal by the on-board unit, and if not, no acoustic signal is emitted by the on-board unit, and storing a current toll transaction together with a current timestamp in the on-board unit.

In some embodiments, the present invention is a method for signaling toll transactions in a road toll system with geographically distributed radio beacons carrying out toll transactions with passing on-board units of vehicles. The method includes: in the course of a toll transaction between an on-board unit and a radio beacon, verifying whether a timer contained in the on-board unit has expired; if so, emitting an acoustic signal is emitted by the on-board unit, and if not, no acoustic signal is emitted by on-board unit; and resetting the timer to the start of its running time.

Both of the above embodiments have the effect that the on-board unit only emits an acoustic signal at the first radio beacon of a chain of successive radio beacons passed, for example, along a highway, so that an undisturbed journey, e.g. via a longer highway section, is ensured. It is only after a longer stop, e.g. a break at a service station, or after the driver actually has left the section furnished with radio beacons, that the on-board unit again emits an acoustic signal when another radio beacon is passed, providing the user with an acknowledgment of the proper operation of the on-board unit when entering a toll road again.

In the first embodiments of the invention which are based on the time stamps assigned by the radio beacons, the on-board units do not have to be equipped with own time components which consume power even in idle mode. For example, it is possible e.g. to use on-board units of conventional road toll systems which allow for a time recording of at least the most recent toll transactions, without any modification for the purposes of the invention. The second embodiments of the invention which are based on timers contained in the on-board units, simplifies the construction of the radio beacons. In some embodiments, the invention provides the possibility to have another acoustic signal emitted by the on-board unit also after the expiration of the timer. This expiration of time signal may be used to signal to the user a completion of the tolling function, e.g. after leaving the section furnished with radio beacons or when making a longer stop.

Both embodiments permit to preset the said time span or running time as a function of the geographical distance of the current radio beacon to the radio beacon located next on the route and as a function of a measured speed value of the on-board unit. This permits to take account of different distances between radio beacons and different traffic flows.

Further, both embodiments of the invention permit to conduct the verification of the timestamp or timer both in the on-board unit and in the radio beacon. The timestamp may be verified, for example, in the radio beacon by this beacon reading out the stored timestamp of the most recent toll transaction from the on-board unit and comparing the readout timestamp with the current timestamp of the current toll transaction and, in case of affirmation, sending a request to the on-board unit to emit the acoustic signal. Alternatively, the times tamp may be verified in the on-board unit by the unit comparing the current timestamp of the current toll transaction with the stored timestamp of the stored toll transaction.

In some embodiments, the present invention is an on-board unit for signaling toll transactions in a road toll system. The on-board units includes: a control unit and a transceiver for carrying out toll transactions with radio beacons which are passed by the onboard-unit along its way; an acoustic signal transmitter for signaling completed toll transactions; and a timer running over a running time which can be reset to the start of the running time by every toll transaction, wherein the control unit is configured to verify, in the course of a toll transaction, whether the timer has expired, and if so, to trigger the signal transmitter to emit an acoustic signal.

In some embodiments, the timer is verified in the on-board unit, because this unit can directly access the timer. In a second aspect, the invention also creates an on-board unit of the above-mentioned type designed to implement the timer version of the method according to the invention where the on-board unit includes a timer running over a running time which can be reset to the start of its running time with every toll transaction, with the control unit being designed to verify in the course of a toll transaction whether the timer has expired, and if so, to trigger the signal transmitter for emitting an acoustic signal.

In some embodiments, the timer, once expired, triggers the signal transmitter to emit an acoustic signal, so that the on-board unit once more generates a signal indicating the completion of its tolling function also when a toll highway is left.

In some embodiments, the on-board unit is set to a power saving mode between toll transactions, in which mode only the transceiver and the timer are supplied with power.

### BRIEF DESCRIPTION OF THE DRAWINGS

The invention is described in further details below by means of exemplary embodiments represented in the attached drawings, in which:

FIG. 1 shows a schematic and partial depiction of a road toll system, according to some embodiments of the present invention.

FIG. 2 shows a block diagram of a radio beacon and on-board unit, according to some embodiments of the present invention.

FIG. 3 shows a process flow diagram, according to some embodiments of the present invention, using the radio beacon and on-board unit of FIG. 2.

FIG. 4 shows a block diagram of a radio beacon and on-board unit, according to some embodiments of the present invention.

FIG. 5 shows a process flow diagram, according to some embodiments of the present invention, using the radio beacon and on-board unit of FIG. 4.

### DETAILED DESCRIPTION

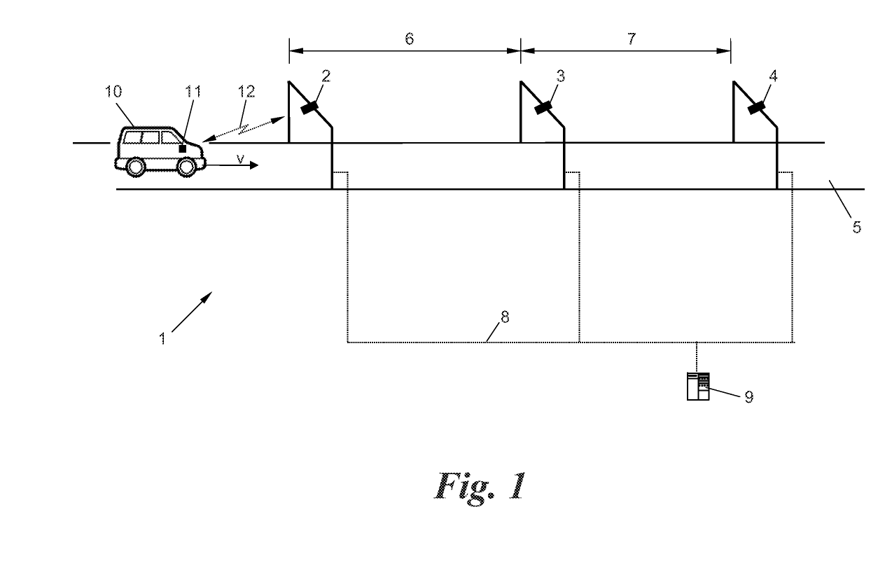

FIG. 1 shows parts of a road toll system 1 comprising a variety of geographically distributed radio beacons 2-4 which for example are installed along a toll road 5 in mutual distances 6, 7. The radio beacons 2-4 are connected to a control center 9 of the road toll system via data links 8. The road toll system 1, in particular its radio beacons 2-4, charges vehicles 10 for passing toll roads, e.g. toll road 5.

Every vehicle 10 is equipped with an on-board unit (OBU) 11 which, when passing a radio beacon 2-4, establishes a short distance wireless connection to this radio beacon carrying out a toll transaction 12, which may be reported to the control center 9 via the data link 8 and/or is stored in the on-board unit 11.

The radio beacons 2-4, the on-board units 11 and their wireless connections are designed for example accordance to the Dedicated Short Range Communication (DSRC) standard, the Wireless Access in a Vehicle Environment (WAVE) standard, the Wireless Local Area Network (WLAN) standard, the Bluetooth standard, the Radio Frequency Identification (RFID) standard, or other radio or infrared standards. Every toll transaction 12 carried out when a radio beacon 2-4 is passed, may debit a specific user fee from a credit account in the control center 9 and/or the on-board unit 11, thus constituting a “debit transaction”. However, the toll transactions 12 may also constitute identification, maintenance, software updating or similar transactions of the road toll system 1.

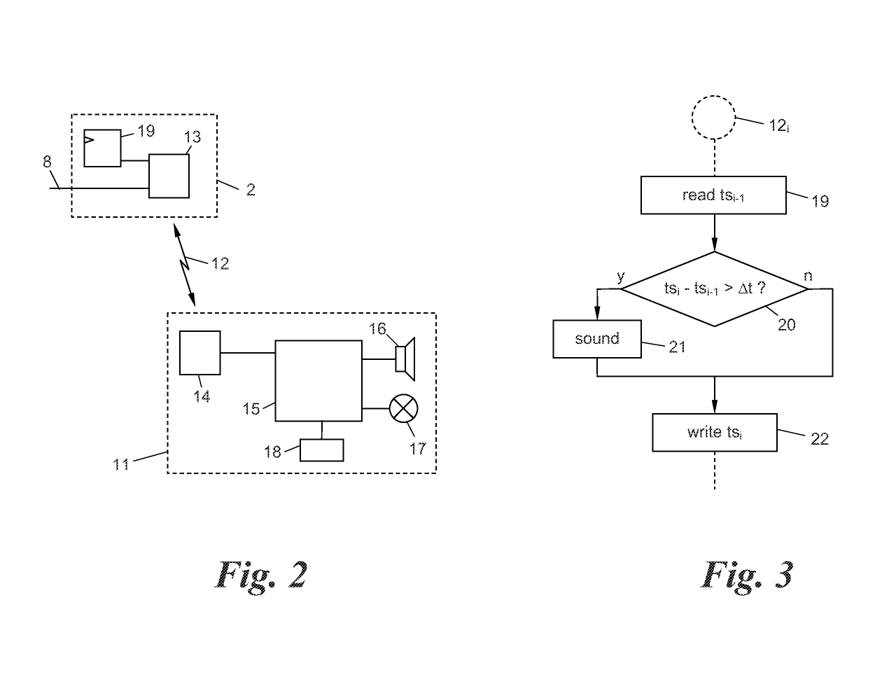

FIG. 2 shows a block diagram depicting one of the radio beacons 2, one of the on-board units 11 and a toll transaction 12 conducted between these two components. The radio beacon 2 comprises a transceiver 13 and the on-board unit 11 comprises a transceiver 14, designed to set up the wireless interface for the toll transaction 12, The on-board unit 11 further contains a control unit, e.g. a processor 15, which communicates with the transceiver 14, an acoustic signal transmitter 16, e.g. a beeper or sound module, an optional visual display 17, e.g. one or several LEDs, and a storage unit 18.

In the embodiments of FIG. 2, the radio beacon 2 comprises a clock module 19 which is able to furnish toll transactions 12 with the timestamp ts indicating the current time, as explained in detail below. Further, the radio beacon 2 may comprise an own processor (not shown) for processing the toll transactions 12 or may be controlled directly by the control center 9.

FIG. 3 shows some embodiments of the method which is carried out in each course of a toll transaction 12 when passing a radio beacon in order to control the acoustic signaling in the on-board unit 11. The method of FIG. 3 is triggered by a toll transaction 12 and is carried out once in a toll transaction 12, but may be carried out at any point of time during the toll transaction 12. A toll transaction 12 usually includes several data packages sent back and forth between the radio beacon 2 and the on-board unit 11, The method of FIG. 3 may then be carried out at the start of, during or at the end of the toll transaction 12. The method may also be carried out in parallel to the toll transaction 12, e.g. in an own process in the radio beacon 2 and/or the on-board unit 11, i.e. it may be “triggered” by the start of a toll transaction 12. The method may be carried out at the end of a toll transaction 12 and then, only if this transaction was successful, the resulting acoustic signal indicates the successful completion of the toll transaction 12.

The method of FIG. 3 is based on furnishing every toll transaction 12 with its own timestamp ts, for example the toll transaction 12ᵢ₋₁ between the on-board unit 11 and the radio beacon 2 with the timestamp tsᵢ₋₁, the toll transaction 12ᵢ between the on-board unit 11 and the radio beacon 3 with the timestamp tsᵢ, the toll transaction 12ᵢ₊₁ between on-board unit 11 and radio beacon 4 with the timestamp tsᵢ₊₁, etc. The storage unit 18 of the processor 15 stores (at least) the most recent toll transaction, generally 12ᵢ₋₁, together with its respective timestamp tsᵢ₋₁, and (at least) until the next toll transaction, generally 12ᵢ, at the next radio beacon.

In step 19 of the method, which is triggered by a current toll transaction 12ᵢ, the timestamp tsᵢ₋₁ of the toll transaction 12ᵢ₋₁ of the previous radio beacon 2 last stored in the storage unit 18 is read out from the on-board unit 11. It is verified in a subsequent decision 20 whether the read-out last timestamp tsᵢ₋₁ dates back longer than a given time span Δt with respect to the current time which e.g. is indicated by the current timestamp tsᵢ of the current toll transaction 12ᵢ, i.e. whether the difference tsᵢ-tsᵢ₋₁ is larger than the given time span Δt. If so (branch “y”), the acoustic signal transmitter 16 is triggered to emit an acoustic signal, e.g. a beep, in step 21. If not (branch “n”), no acoustic signal is emitted or the signal requested by the radio beacon 2 is suppressed. Subsequently, in step 22, the timestamp tsᵢ of the current toll transaction 12ᵢ is stored again in the storage unit 18 of the on-board unit 11.

In a new toll transaction 12ᵢ₊₁ when the next radio beacon is passed, e.g. at the radio beacon 4, this timestamp tsᵢ may in turn be read out as the stored last timestamp of the previous toll transaction 12ᵢ, etc.

With respect to the verification step 20, the method of FIG. 3 may be carried out in the radio beacon 2 or in the on-board unit 11. In the first case, the radio beacon 2 reads out the last timestamp tsᵢ₋₁ stored in the on-board unit 11 and afterwards in step 21 sends a request to the onboard unit 11 to emit an acoustic signal. In the second case, in step 20, the on-board unit 11 for itself verifies the current timestamp tsᵢ of the current toll transaction 12ᵢ against the stored last timestamp tsᵢ₋₁ of the previous toll transaction 12ᵢ₋₁.

The given time span Δt may be constant and may be selected according to an average distance 6, 7 of the radio beacons 2-4 and an average driving speed of the vehicle 10 so as to ensure that the time span Δt is actually not exceeded, given a continuous drive via successive radio beacons 2, 3, 4. As a result, the acoustic signal is emitted only at the first radio beacon of a chain of radio beacons 2 4, as there is no previous toll transaction 12ᵢ₋₁ with a previous timestamp tsᵢ₋₁, or this timestamp tsᵢ₋₁ dates back for such a long time that the given time span Δt has been exceeded.

The given time span Δt may also be variable, i.e. as a function of the respective distance 6, 7 to the next radio beacon, alternatively or additionally, as a function of the respective current driving speed v of the vehicle 10. Based on the distance 6, 7 and the driving speed v, an estimated travel time may be calculated within which the next radio beacon to be passed is expected. The time span Δt may then be set to be, for example, slightly larger than the estimated travel time.

The information about the distance 6, 7 between the radio beacons 2-4 or to the next radio beacon may be stored in the radio beacon 2-4, or in the on-board unit 11. The respective distance 6, 7 of the radio beacons may then be used in the decision 20 in connection with an average or currently measured driving speed v. Depending on where the decision 20 is made, the corresponding values of the distance 6, 7 and/or the measured speed value v and/or calculated time span Δt may be communicated between the radio beacon 2 and the on-board unit 11 may, where necessary. The measured speed value v may be measured by the radio beacon 2 or by the on-board unit 11 by speed measurement equipment or it may be received from a speed sensor of the vehicle 10.

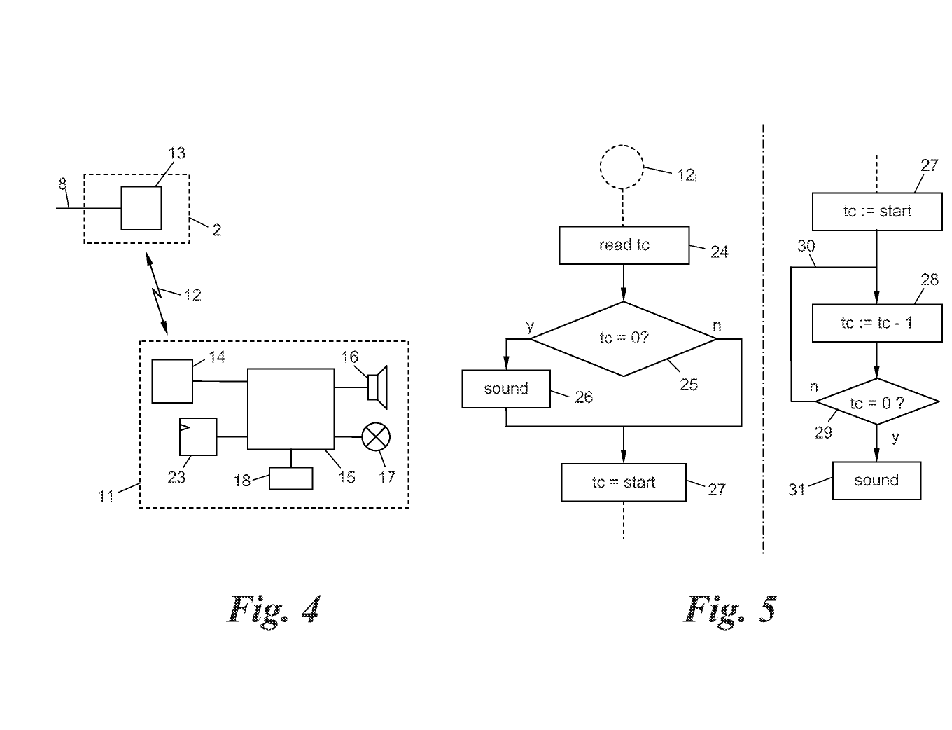

FIG. 4 and FIG. 5 show modified embodiments, where the same reference signs designate the same elements as in FIGS. 1 to 3. Therefore, only the differences against the embodiment of FIG. 2 and FIG. 3 will be described. All versions and components described for the purpose of FIG. 2 and FIG. 3 may also be used in the embodiments of FIG. 4 and FIG. 5, and vice versa.

FIG. 4 shows the on-board unit 11 containing a timer 23, e.g. a timer component, a monoflop, a counter or the like. The timer 23 is running over a given running time which has the same function and the same values like the time span of the embodiment of FIG. 2 and FIG. 3 and therefore may also be designated using the same variable Δt.

The running time Δt of the timer 23 may be realized in many different ways. When the timer 23 is a counter counting backwards to zero with the counter value tc, the “start” value of the counter, in conjunction with its counting speed, defines the running time Δt. When the timer 23 is a monoflop, the running time Δt is defined by the monostable cycle time of the monoflop. When the timer 23 is a clock module, the running time Δt results from the time between the current time and a presettable end time, and the like.

Each toll transaction 12 carried out the between the on-board unit 11 and a radio beacon 2-4, re-triggers the timer 23, i.e. resets the timer to the start of its running time Δt. When embodied as a counter, the timer 23 is reset to the “start” value. When embodied as a monoflop, this monoflop is re-triggered by each toll transaction 12.

Between the toll transactions 12, the on-board unit 11 may be set to a power saving mode, i.e. whenever located within the distances 6, 7 or outside the toll road 5, in which mode only the timer 23 and the most important components, like the transceiver 14, are supplied with power.

The left half of FIG. 5 illustrates the method for controlling the signaling by the acoustic signal transmitter 16 using the timer 23 of the on-board unit 11. Once triggered by a current toll transaction 12, a first step 24 reads out the current status of the timer 23, e.g. its counter value, if the timer is embodied as a counter. A subsequent decision step 25 verifies whether the timer 23 has been expired, e.g. whether a reverse counter has reached zero. If so (branch “y”), the acoustic signal transmitter 16 is triggered to emit an acoustic signal in step 26. If not (branch “n”), no acoustic signal is emitted or the signal requested by the radio beacon 2 is suppressed.

In step 27, the timer 23 is reset to the start of its running time Δt, e.g. the counter is reset to its “start” value. This corresponds to a “re-triggering” of the timer 23 by the current toll transaction 12ᵢ.

Thus, where the periodic re-triggering of the timer 23 by successive toll transactions 12ᵢ, 12ᵢ₊₁, etc., is omitted at radio beacons passed successively for at least the current running time Δt of the timer 23, the timer 23 has been expired when passing the next radio beacon in step 25 and an acoustic signal is emitted, but otherwise not.

The right half of FIG. 5 illustrates a timer 23 designed as a reverse counter which, once triggered, runs irreversibly, see reverse counting process 28, verification step 29 to zero, and loop 30.

As an option, an acoustic signal may also be emitted whenever the timer 23 has expired (branch “y” in step 29), see step 31. As a result, the on-board unit 11 emits an acoustic signal also after passing a chain of successive radio beacons 2-4 after the expiration of the last running time Δt, was is equivalent to signaling the completion of its tolling function along the chain of radio beacons 2-4, even though with the delay of Δt.

With respect to the verification step 25, the method as embodied in FIG. 4 and FIG. 5 may also be carried out in the radio beacon 2, whenever the status or counter value tc of the timer 23 is read out in the radio beacon 2 in step 24 and the request 26 to emit a signal is sent back by the radio beacon 2 to the on-board unit 11. The entire method may be carried out in the on-board unit 11, particularly since this unit also emits the signal in step 31 autonomously, after passing the last radio beacon.

It will be recognized by those skilled in the art that various modifications may be made to the illustrated and other embodiments of the invention described above, without departing from the broad inventive step thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A method for signaling toll transactions in a road toll system with geographically distributed radio beacons carrying out toll transactions with passing on-board units of vehicles, the method comprising:
in the course of a toll transaction between an on-board unit and a radio beacon, verifying whether a toll transaction stored last in the on-board unit together with a timestamp dates back longer than a given time span;
if so, emitting an acoustic signal by the on-board unit, and if not, no acoustic signal is emitted by the on-board unit; and
storing a current toll transaction together with a current timestamp in the on-board unit.

2. The method according to claim 1, wherein the given time span is preset as a function of the geographical distance of the radio beacon to radio beacon located next and a measured speed value of the on-board unit.

3. The method according to claim 1, wherein said verification is conducted in the radio beacon, by the radio beacon reading out the stored timestamp from the on-board unit, comparing the readout timestamp with the current timestamp of the current toll transaction, and sending a request to the on-board unit to emit the acoustic signal according to comparing.

4. The method according to claim 1, wherein said verification is conducted in the on-board unit by comparing the current timestamp of the current toll transaction with the stored timestamp of the stored toll transaction.

5. The method according to claim 1, further comprising setting the on-board unit to a power saving mode between toll transactions.

6. A method for signaling toll transactions in a road toll system with geographically distributed radio beacons carrying out toll transactions with passing on-board units of vehicles, the method comprising:
in the course of a toll transaction between an on-board unit and a radio beacon, verifying whether a timer contained in the on-board unit has expired;
if so, emitting an acoustic signal by the on-board unit, and if not, no acoustic signal is emitted by the on-board unit; and
resetting the timer to the start of its running time.

7. The method according to claim 6, further comprising emitting an acoustic signal by the on-board unit after expiration of the timer.

8. The method according to claim 6, wherein in said timer reset, a running time is set as a function of the geographical distance of the radio beacon to a radio beacon located next and a measured speed value of the on-board unit.

9. The method according to claim 6, Wherein said verification is conducted in the on-board unit.

10. The method according to claim 6, wherein the on-board unit is set to a power saving mode between toll transactions.

11. An on-board unit for signaling toll transactions in a road toll system comprising:
a control unit and a transceiver for carrying out toll transactions with radio beacons which are passed by the onboard unit along its way;
an acoustic signal transmitter for signaling completed toll transactions; and
a timer running over a running time which can be reset to the start of said running time by every toll transaction, wherein the control unit is configured to verify, in the course of a toll transaction, whether the timer has expired, and if so, to trigger the signal transmitter to emit an acoustic signal.

12. The on-board unit according to claim 11, wherein the timer, once expired, triggers the signal transmitter to emit an acoustic signal.

13. The on-board unit according to claim 12, wherein the running time of the timer is controlled by a measured value of the speed of the on-board unit.

14. The on-board unit according to claim 13, wherein the running time of the tinier is controlled by location information received by the on-board unit from a radio beacon in the course of a toll transaction.

15. The on-board unit according to claim 14, wherein the on-board unit is set to a power saving mode between toll transactions, in which only the transceiver and the timer are supplied with power.
